(19) United States
(12) Patent Application Publication
(10) Pub. No.: US 2008/0171470 A1
(43) Pub. Date: Jul. 17, 2008

(54) Electrical connector

(75) Inventor: Wen-Qiang Ma, ShenZhen (CN)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 12/009,292

(22) Filed: Jan. 17, 2008

(30) Foreign Application Priority Data
Jan. 17, 2007 (CN) 200720033662.4

(51) Int. Cl. H01R 13/648

(52) U.S. Cl. 439/607

(57) ABSTRACT

An electrical connector for receiving an electronic component therein, comprises an insulating housing comprising a front wall, a rear wall, a pair of opposite sidewalls, and a footwall together forming a receiving room, a plurality of contacts mounted in the housing, and a shell covering the housing. The footwall of the housing is approximately symmetrical H-shaped and comprises an elongated body and a pair of wings extending from the two opposite ends of the body. The two wings respectively connect the front wall and the rear wall of the housing.

### BACKGROUND OF THE INVENTION

1. Field of the Invention

The present invention relates to an electrical connector, and particularly to an electrical connector used for a mobile phone or other electrical devices.

2. Description of the Prior Art

With the rapid development of the technology of wireless communication and advanced technology of electronics, the electronic consumer products such as mobile phone, Personal Digital Assistant (PDA) etc., are designed to comply with miniaturization trend and multiple functions such as mounting a camera thereon to meet a user's need. As a result, the requirement of socket connectors used in such equipments is correspondingly demanding.

An electrical connector for receiving an electrical component comprises an insulating housing, a plurality of contacts insert-molded with the housing, and a top shell and a bottom shell together covering the housing. The housing comprises four sidewalls and a footwall together forming a receiving room for receiving the electrical component. The bottom shell has a base sustaining the footwall of the housing. The footwall of the housing is elongate-board-shaped and connects two opposite sidewalls for holding the electrical component.

However, one problem of above said connector is that when assemble the electrical component into the receiving room, the elongate-board-shaped footwall only holds the central bottom of the electrical component, once a sloping force pressing on the electrical component, or the electrical device falling onto the ground suddenly, one side of the electrical component slants onto the base of the bottom shell, and the footwall is damaged probably, even the printed circuit board electrically connecting the connector and lying under the base of the bottom shell may be damaged.

Hence, an improved electrical connector is desired to overcome the disadvantages of the prior art.

### BRIEF SUMMARY OF THE INVENTION

Therefore, a main object of the present invention is to provide an electrical connector which supplies firmly holding force between the top shell and the housing of the connector.

To fulfill the above-mentioned object, an electrical connector according to the present invention comprises an insulating housing comprising a front wall, a rear wall, a pair of opposite sidewalls, and a footwall together forming a receiving room, a plurality of contacts mounted in the housing, and a shell covering the housing. The footwall of the housing is approximately symmetrical H-shaped and comprises an elongated body and a pair of wings extending from the two opposite ends of the body. The two wings respectively connect the front wall and the rear wall of the housing.

Other objects, advantages and novel features of the invention will become more apparent from the following detailed description when taken in conjunction with the accompanying drawings.

### BRIEF DESCRIPTION OF THE DRAWINGS

The foregoing summary, as well as the following detailed description of the embodiments of the present invention, will be better understood when read in conjunction with the appended drawings. For the purpose of illustrating the invention, there are shown in the drawings embodiments which are presently preferred. As should be understood, however, the invention is not limited to the precise arrangements and instrumentalities shown. In the drawings:

FIG. 1 is a perspective view of an electrical connector of the present invention.

FIG. 2 is an exploded view of FIG. 1.

FIG. 3 is an amplificatory view of the insulating housing of FIG. 1.

### DETAILED DESCRIPTION OF THE PREFERRED EMBODIMENT

Reference will now be made in detail to the preferred embodiment of the present invention.

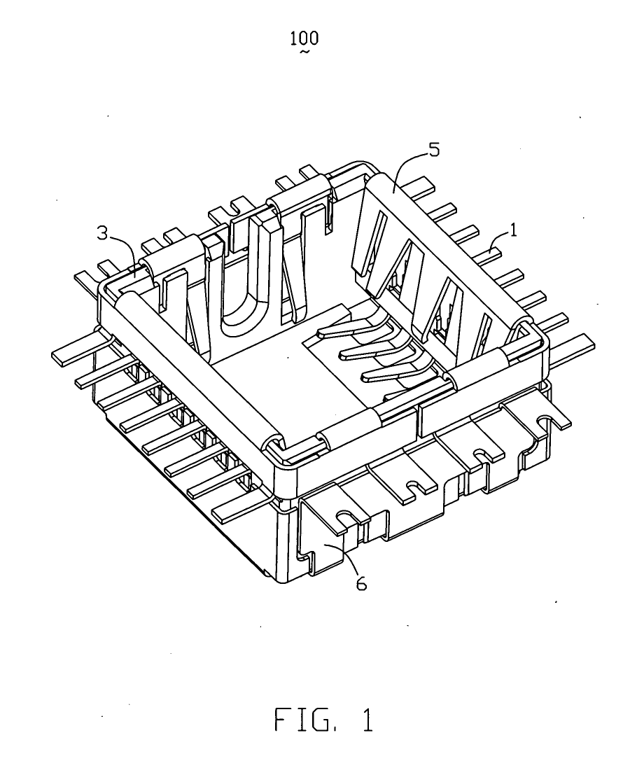

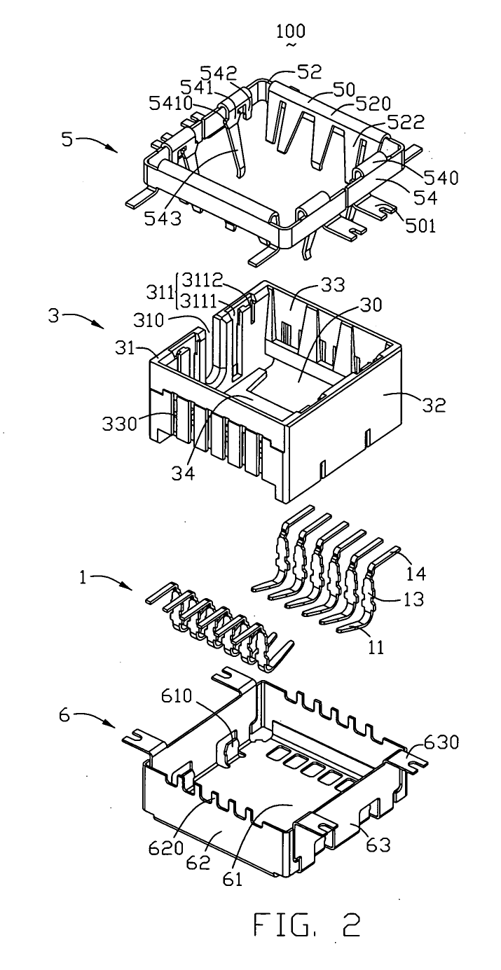

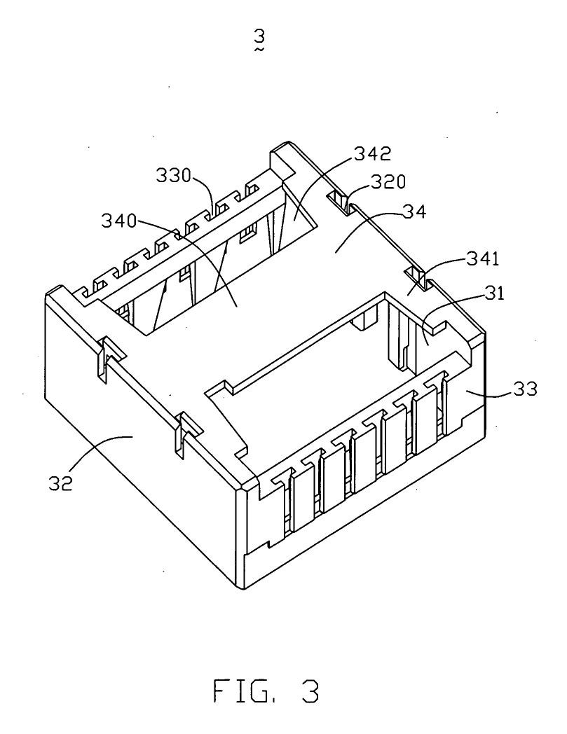

Referring to FIGS. 1-3, an electrical connector 100 according to the present invention is adapted for receiving an electrical component and in this embodiment said electrical component is a camera module (not shown). The electrical connector 100 comprises an insulating housing 3 defining a receiving room 30, a plurality of contacts 1 mounted in the housing 3, a top shell 5 and a bottom shell 6 together covering the housing 3.

The top shell 5 mounted on the top of the housing 3 consists of a pair of U-shaped metal frames 50. Each frame 50 comprises a pair of approximately symmetrical first wall 54 and a second wall 52 connecting the two first walls 54. A first bending portion 520 extends from the top of the second wall 52 and bends toward the receiving room 30. Several first resilient arms 522 extend from the free end of the first bending portion 520 to the receiving room 30 for engaging with the camera module firmly. A second bending portion 540 extends from the top of the first wall 54 and bends toward the receiving room 30. A first assembling portion 541 and a second assembling portion 542 extends from the free end of the second bending portion 540 downwardly. A pair of tabs 5410 protrudes from the two sides of the first assembling portion 541 for engaging with the housing. The first assembling portion 541 and the second assembling portion 542 together constitute a double-row assembling portion. A second resilient arm 543 extends from the bottom of the first assembling portion 541 to the receiving room 30 for engaging with the camera module. Several first soldering portions 501 perpendicularly bend from the bottom of the second wall 52 and the bottom of the first wall 54.

The bottom shell 6 for covering the bottom of the housing 3, comprises a planar base 61, a pair of third walls 63 and a pair of fourth walls 64 extending from the four sides of the base 61 upwardly. Two pairs of engaging patches 610 are formed at the base 61 adjacent to the two opposite fourth walls 63 engaging with the housing 3 for fixing the bottom shell 6 onto the housing 3. A pair of second soldering portions 630 extends from the top of each fourth wall 64 outwardly. Several tabs 620 extend from the top of the third wall 62 upwardly, and every two adjacent tabs 620 have same distance.

The housing 3 comprises a front wall 31, a rear wall 32, a pair of sidewalls 33 connecting the front wall 31 and the rear wall 32, and a footwall 34 together forming the receiving room 30 for receiving the camera module. A cutout 310 is defined at a central portion of the front wall 31 for accommodating a projecting portion (not shown) of the camera module. Several notches 320 are defined on the bottom of the front wall 31 and the rear wall 32 engaging with the engaging tabs 610 for fastening the bottom shell 6 and the housing 3 firmly. Two pairs of double-row assembling grooves 311 are respectively defined on the front wall 31 and the rear wall 32 engaging with the corresponding double-row assembling portions for fastening the top shell 5 and the housing 3 firmly. Each double-row assembling groove comprises a first assembling groove 3111 engaging with the corresponding tabs 5410 of the first assembling portion 541, and a second assembling groove 3112 engaging with the corresponding second assembling portion 542. A plurality of slits 330 is defined on each sidewall 33. The footwall 34 is H-shaped, and comprises an elongated body 340 and a pair of wings 341 extending respectively from the two opposite ends of the body 340. The wings 341 respectively connect the front wall 31 and the rear wall 32 for burdening the camera module. The footwall has two approximately symmetrical cavities 342 among the wings 341 for receiving the contact 1.

The contact 1 is mounted on the corresponding slit 330 of the housing 3 and comprises a fastening portion 13 engaging with the slit 330, a conducting portion 11 bending and extending from the bottom of the fastening portion 13 receiving in the receiving room 30, and a third soldering portion 14 extending from the top of the fastening portion 13 outwardly and lying between the two adjacent tabs 620.

In use, firstly, the first soldering portions 501, the second soldering portions 630, the third soldering portions 14 of the connector are respectively soldered onto the corresponding conducting pad (not shown) of the printed circuit board (not shown); then the camera module is put into the receiving room, so the resilient arms 522, 543 engage with the camera module and the conducting portions 11 of the contacts 1 respectively contact the corresponding conducting areas (not shown) of the camera module. A circuit path is completed.

In the present invention, the H-shaped footwall 34 burdens the camera module. Compare to the related arts, the footwall only having an elongated body burdening the camera module, the footwall of the connector of the present invention is pressed averagely when assemble the camera module into the receiving room, and the connector of the present invention could prevent the electrical component deflecting in the receiving room and then striking the base of the bottom shell.

It is to be understood, however, that even though numerous, characteristics and advantages of the present invention have been set fourth in the foregoing description, together with details of the structure and function of the invention, the disclosed is illustrative only, and changes may be made in detail, especially in matters of shape, size, and arrangement of parts within the principles of the invention to the full extent indicated by the broad general meaning of the terms in which the appended claims are expressed.

What is claimed is:

1. An electrical connector for receiving an electronic component therein, comprising:
an insulating housing comprising a front wall, a rear wall, a pair of opposite sidewalls, and a footwall together forming a receiving room;
a plurality of contacts mounted in the housing; and
a shell covering the housing;
wherein the footwall of the housing is approximately H-shaped and comprises an elongated body and a pair of wings extending from two opposite ends of the body and respectively connecting the front wall and the rear wall of the housing.

2. The electrical connector as described in claim 1, wherein the shell comprises a top shell mounted onto the top of the housing and a bottom shell covering the bottom of the housing.

3. The electrical connector as claimed in claim 2, wherein the top shell comprises a pair of opposite first walls and a pair of opposite second walls, a bending portion extending from the top of the first wall and bending toward the receiving room, a double-row assembling portion extending from the free end of the bending portion downwardly; and wherein the housing defines a corresponding double-row assembling groove engaging with the assembling portion for mounting the top shell onto the housing.

4. An electrical connector comprising:
an insulative housing including first four side walls commonly defining a receiving cavity;
a plurality of contacts retained in the housing with mating sections extending into the receiving cavity;
a lower metallic shell defining second four side walls surrounding lower portions of said first four side walls; and
an upper metallic shell defining third four side wall surrounding upper portions of said first four side walls; wherein
at least one of said second four side walls define a plurality of first horizontal plates, and the corresponding one of said third four side walls define a plurality of second horizontal plates under a condition that said first horizontal plates are essentially coplanar with said second horizontal plates while alternately arranged with each other with interference therebetween.

5. The electrical connector as claimed in claim 4, wherein said contacts include a plurality of tails extending outward between upper edges of the third four side walls and lower edges of the second four side walls.

6. The electrical connector as claimed in claim 5, wherein said tails are coplanar with the first horizontal plates and the second horizontal plates.

7. An electrical connector comprising:
an insulative housing including first four side walls commonly defining a receiving cavity;
a plurality of contacts retained in the housing with mating sections extending into the receiving cavity;
a lower metallic shell defining second four side walls surrounding lower portions of said first four side walls; and
an upper metallic shell defining third four side wall surrounding upper portions of said first four side walls; wherein
said contacts include a plurality of tails extending outward between upper edges of the third four side walls and lower edges of the second four side walls.

8. The electrical connector as claimed in claim 7, wherein at least either said first side walls or said second side walls define a plural of horizontal plates which is coplanar with said tails.
